(19) United States
(12) Patent Application Publication
(10) Pub. No.: US 2021/0280839 A1
(43) Pub. Date: Sep. 9, 2021

(54) ELECTRODE EXTENSION OVERLAP CONFIGURATIONS IN BATTERY

(71) Applicant: James E. Beecham, West Palm Beach, FL (US)

(72) Inventor: James E. Beecham, West Palm Beach, FL (US)

(21) Appl. No.: 17/092,035

(22) Filed: Nov. 6, 2020

Related U.S. Application Data
(63) Continuation-in-part of application No. 17/064,243, filed on Oct. 6, 2020.
Application No. 17/064,243 is a continuation-in-part of application No. 17/033,853, filed on Sep. 27, 2020.
Application No. 17/033,853 is a continuation-in-part of application No. 16/867,273, filed on May 5, 2020, now Pat. No. 10,800,434.
(60) Provisional application No. 62/986,682, filed on Mar. 7, 2020.

(51) Int. Cl. H01M 2/26; H01M 10/0525; H01M 10/0587

(52) U.S. Cl. CPC H01M 2/263; H01M 10/0587; H01M 10/0525

(57) ABSTRACT

A battery comprising a plurality of electrode extensions comprising at least one area of at least partial overlap of one extension over another. Typically, said overlaps occur at least near to battery cap contact area for electrode extensions. Said overlaps enable end plate of ‘jelly-roll’ of battery materials to be formed from and maintained by progressive folding down of extensions during battery winding. Such overlaps are suitable for electrical contact to battery cap. Said overlaps enable short average electron path lengths in batteries, and thus mitigate against heat damage to battery during recharge. Said overlaps are supportive of efficient high-speed battery manufacture.

### CROSS-REFERENCE TO RELATED APPLICATION

The present invention claims priority to non-provisional application Ser. No. 17/064,243 filed 6 Oct. 2020 by instant inventor, entitled ELECTRIC VEHICLE BATTERY PACKS COMPRISING TABLESS/MULTI-TAB CYLINDRICAL JELLY-ROLL STYLE BATTERY CELLS, which claims priority to non-provisional application Ser. No. 17/033,853 filed 27 Sep. 2020 by instant inventor, entitled ELECTRIC VEHICLE SAFETY AS TO SIDE COLLISIONS AND BATTERY PACK PLACEMENT IN MANUFACTURING, which claims priority to non-provisional application Ser. No. 16/867,273 filed 5 May 2020 by instant inventor regarding vehicle safety, entitled A METHOD AND SYSTEM FOR MITIGATING ANTICIPATED RISKS IN SELF-:DRIVING VEHICLES Lk USE OF MALICIOUS ROADWAY FALSIFIED APPEARANCES now issued U.S. Pat. No. 10,800,434 of 13 Oct. 2020, which claims priority to provisional application Ser. No. 62/298,6682 filed Mar. 7, 2020, hereby incorporated in their entirety at least by reference.

### 1. Field of the Invention

The present invention generally relates to batteries. More specifically, present invention relates to overlap configurations of electrode extensions in battery.

### BRIEF SUMMARY OF THE INVENTION

In a preferred embodiment, a battery cell includes a first substrate electrode having a first coating disposed thereon, wherein a second portion of the first substrate electrode comprises a conductive material at a proximal end along the width of the first substrate electrode. An inner separator is disposed over the first substrate. A second substrate is disposed over the inner separator. The second substrate electrode has a second coating disposed thereon. The first substrate, the inner separator, and the second substrate in a successive manner, the first substrate, the inner separator, and the second substrate are rolled about a central axis in a jelly roll style of battery configuring.

In a preferred embodiment, said first substrate electrode forms one of an anode and a cathode and the second substrate electrode forms another of the anode and the cathode. In a preferred embodiment, said jelly roll style battery comprises an energy storage device comprising a can comprising a first end and a second end. The first end comprises a first cap comprising an interior contact surface wherein the conductive material of a plurality of extensions of one substrate electrode are in electrical contact with the said first cap in contact area of interior surface. In a preferred embodiment, said electrical contact of the first cap to the said first substrate electrode extensions comprises at least partially overlapped extensions of said first substrate electrode. The term ‘overlap’ as herein defined, has a verb meaning: ‘to extend over and cover at least partly’; and a noun meaning: ‘a part or amount which overlaps’.

In a preferred embodiment, said at least partially overlapped extensions are configured wherein the said overlap enables mitigation of heat during battery operations by enabling multiple electron pathways. In a preferred embodiment, said mitigation of battery heat comprises relatively short average electron path in battery, s as less than 70 mm. In a preferred embodiment, at least one electron path comprises electrons passing from a first overlapped extension, thence via the said overlapping extension, and thence to the cap.

In a preferred embodiment, the extensions can be said to have an end near the cap and an opposite end near the origin of the extension from the electrode sheet. In a preferred embodiment, an overlapped portion formed by at least two extensions is comprised at least near the cap contact end of the respective extensions, as opposed to the origin ends. In a preferred embodiment, the extensions are non-overlapped in the proximal ‘near-to-origin-at-sheet’ aspect, but at least partially overlapped at their parts near to contact area of the cap.

In a preferred embodiment, an effective electrical connection occurs respectively between overlapped electrode extensions and the cap, including in the area wherein the overlap is present. In a preferred embodiment, the cap contact to extension is at least one of: direct or indirect.

In a preferred embodiment, the direct contact is extension physically contacting the cap, and the indirect contact comprises an electron path from overlapped extension to at least one overlapping extension and thence to cap. In a preferred embodiment, the ease of initiation and maintenance of such effective electrical connection pathways set is a function of the configuration of the components.

The cap battery-interior-facing surface configuration and the at least partial overlap of extensions of electrode at the cap-contact location, these mutually enable rapid establishment of said effective electrical connection via multiple electron pathways. In a preferred embodiment, such rapid establishment is enabled by plurality of overlapped electrode extensions comprising an end plate of ‘jelly-roll’ of battery materials.

Said end plate in contact to cap establishes multiple electron pathways, a benefit in keeping battery from overheating. In a preferred embodiment, no additional expenditure of time or connecting materials is needed to establish electrical connection beyond snugly pressing together said end plate and cap interior and securing them in place. Thus, high-speed manufacture of batteries is enabled, defined as one line of production producing at least 200 batteries per hour.

In a preferred embodiment, the high-speed manufacturing enablement comprises winding of ‘jelly-roll’ while progressive folding down electrode extensions during winding. This leads to an end plate of flat to smoothly concave surface, comprising folded-down partially overlapped extensions.

In a preferred embodiment, said end plate maintains its shape at least in part due to the snugness of extension overlapping. Such a flat end plate surface enables establishment of efficient electrical contact between extensions and cap. When ‘jelly-roll’ battery materials are slid into battery can, said flat end plate surface more readily accepts toothed contact at cap contact points. In a preferred embodiment, such enablement of overlapped extensions to make and maintain a flat end plate supports high-speed battery manufacture.

### BRIEF DESCRIPTION OF THE FIGURES

Other features and advantages of the present invention will become apparent when the following detailed description is read in conjunction with the accompanying drawings, in which:

FIG. 1 is a schematic of a preferred embodiment.

FIG. 2 is a schematic of a preferred embodiment.

FIG. 3 is a schematic of a preferred embodiment.

### DETAILED DESCRIPTION OF PREFERRED EMBODIMENT

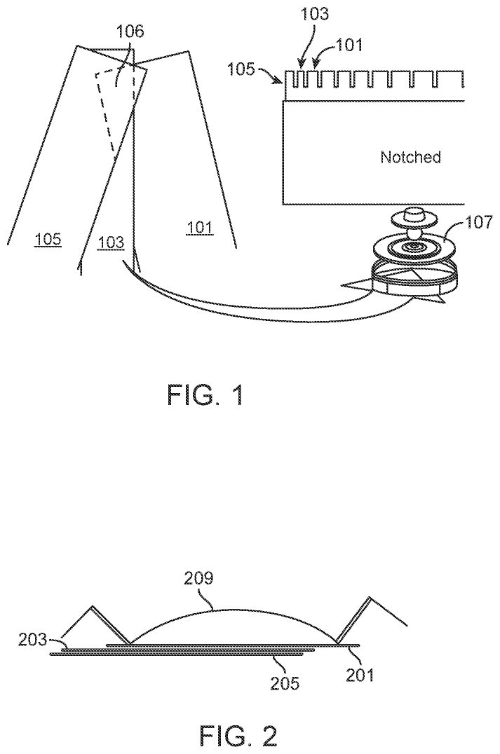

In FIG. 1, a schematic of a preferred embodiment comprises a battery substrate wherein extensions (101, 103, 105) of same electrode are illustrated. Winding said substrate electrode into a cylindrical battery while progressively folding down the extensions, renders the said extensions into a partially overlapped end plate configuration. The illustrated overlap comprises, in a roughly triangular area marked by dotted line, overlap of all three of the extensions (106). When the wound battery materials are placed into the can (107), the at least partially overlapped extensions illustrated have been progressively folded down to comprise at least a portion of a flat end plate to the ‘jelly-roll’ of wound battery materials. Such end plate is leading aspect of ‘jelly-roll’ as it is inserted, and thus the overlapped extensions make electrical contact with the undersurface of the battery cap, at least in some areas. Such contacts can establish an electrical connection comprising multiple electron pathways. Said connections of extension and cap can be direct from one extension physically pressed to the cap, or connection can be via electron path comprising a first extension and via at least a second overlapping extension and then into cap. In the area 106, at least one electron pathway comprises route progressively through each of the three extensions, such as starting from the most distant from the cap, to next most distant, to closest to cap, and then into cap.

In a preferred embodiment, a plurality of electrode extensions comprises tabs, each separated from each other at origin by at least a narrow notch. The notches in another embodiment can vary from narrow to wide. The extensions can be smaller width, such as for extensions destined to be nearer the axis of winding. The extensions can be configured to be wider in parts of the substrate electrode destined to be further from the central axis of winding. The extensions can be rectangular as illustrated, or the extensions can be shaped in non-linear sides and non-regular widths. The extensions can be of same length, as illustrated, or the extensions can be configured with some extensions longer than others.

In FIG. 2, a schematic of a preferred embodiment is illustrated wherein the battery, typically a cylindrical lithium ion jelly-roll type battery, comprises an interior surface of the battery cap configured for contact to electrode extensions. This surface is magnified in view 209 and is in cross-section. In FIG. 2, as a preferred embodiment, the interior surface of the cap comprises a tooth-concave-tooth to at least in areas, as illustrated in cap cross-section 209. Partially overlapped electrode extensions are shown, corresponding to 106 area style of overlap of three electrode extensions. Thus, the three illustrated extension components, comprising area of ‘triple’ overlap wherein three extensions are shown (201, 203, 205) in cross-section. The overlapped three extensions are in electrical contact to each other. Thus, a feasible electron path comprises start in the lowest of the three extensions drawn (205), then path goes to the middle extension (203), and path then goes to the top extension (201), and path then goes to battery cap at 209, via one of the toothed contact areas.

For electron path starting as transiting the middle extension (203), the path can be described as from middle to top extension (201) and then into cap. The configurations of the multiple electron paths of instant invention is key to heat mitigation in the instant battery. By electrons having relatively shorter average electron paths to use within the battery, at least as compared to a single tab configuration, the instant invention battery comprises efficient heat mitigation. Rapid charging is less likely to overheat the battery.

In a preferred embodiment, the instant invention comprises at least one electrode extension separated, at least partially from battery cap interior, by at least one intervening electrode extension. The configurations of the instant invention herein disclosed tend to enable contact easily for batteries as they are assembled. Thus, the instant invention configurations enable high-speed battery manufacturing.

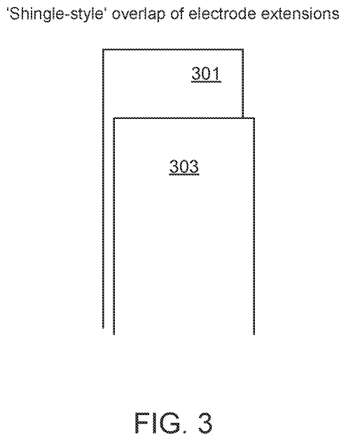

It is understood that the overlap of extensions need not be side over side, as drawn in FIG. 2. Overlap can occur in a variety of styles, such as ‘shingle’ style overlap as drawn in FIG. 3.

It is understood that where a first extension has an intervening overlapping extension separating it from a first contact point at battery cap, said same first extension may have direct contact to a second contact point of battery cap surface. In other words, one electrode extension can contact multiple areas of interior of cap surface. Some of these contacted areas by the electrode extension may have at least partial intervening overlap of extension. Others may not.

In FIG. 3, a schematic of a preferred embodiment illustrates overlapped electrode extensions in what is herein termed a ‘shingle’ overlap configuration. In this configuration, the interior of the battery cap is in contact by toothed area (not shown), which toothed area is understood to directly contact the far surface of extension 301. Thus extension 303, at least in this overlapped area, is not in direct contact to the same toothed area as 301 because 301 is the intervening electrode extension. The 301 extension physically contacts the battery cap, while 303 extension does not. Nevertheless, electrons of extension 303 can have pathway to same toothed area as 301 contacts. This pathway is said to be indirect, and comprises passage from extension 303, then via extension 301, then to area of direct 301 physical contact to cap in this area.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1-20. (canceled)

21. A cylindrical battery comprising at least one electrode comprising plurality of extensions, said plurality comprising at least two extensions which mutually comprise face-to-face shingle overlap contact in end-plate, said contact comprising flat multi-layer plane comprising at least one axis aligned parallel to longitudinal axis of battery cylinder.

22. The cylindrical battery of claim 21, wherein said at least two extensions comprise at least one electrical contact to battery cap.

23. A method of configuring cylindrical battery end plate comprising step of establishing in end plate at least one face-to-face flush shingle overlap between at least two extensions of same electrode, the flat multi-layer plane of said overlap comprising at least one axis parallel to longitudinal axis of battery cylinder.

24. The method of claim 23, further comprising step of configuring said at least two extensions in electrical contact to battery cap.

25. A configuration for wound end-plate of cylindrical battery wherein physical contact is present between rectangular electrode extensions of same electrode, said contact comprising flat multi-layer plane comprising at least one shingle face-to-face overlap comprising at least two of said extensions, the said flat multi-layer plane comprising at least one axis parallel to longitudinal axis of said cylindrical battery.

26. The overlapped extensions of claim 25, further comprising electrical contact to battery cap.
